(19) United States
(12) Patent Application Publication
(10) Pub. No.: US 2017/0276624 A1
(43) Pub. Date: Sep. 28, 2017

(54) SMART ELECTROCHEMICAL PROCESSING APPARATUS

(71) Applicant: MONOLITH STUDIO, INC., Zhubei City, Hsinchu County (TW)

(72) Inventors: Chih-Chung CHEN, Zhubei City, Hsinchu County (TW); Kevin HUANG, Taipei City (TW)

(21) Appl. No.: 15/506,575

(22) PCT Filed: Sep. 8, 2015
(86) PCT No.: PCT/CN2015/000633

§ 371 Date: Feb. 24, 2017

Related U.S. Application Data
(60) Provisional application No. 62/111,733, filed on Feb. 4, 2015.
(60) Provisional application No. 62/047,716, filed on Sep. 9, 2014.

(51) Int. Cl. G01N 27/07; G01N 27/30; C25B 15/02; C25D 21/14; C25D 21/02; C25D 21/06; G01N 27/403; C25D 21/10

(52) U.S. Cl. CPC G01N 27/07; G01N 27/403; G01N 27/30; C25D 21/10; C25D 21/14; C25D 21/02; C25D 21/06; C25B 15/02; C25C 7/00

(57) ABSTRACT

A smart electrochemical processing apparatus includes a reaction container, an electrode unit and a surface feature scanner. The reaction container has an electrolytic tank. The electrode unit has a first electrode fixed to the electrolytic tank and a second electrode rotatably positioned at the electrolytic tank. The surface feature scanner is positioned at the electrolytic tank. Before being put in the electrolytic tank for processing, a workpiece positioned at the second electrode is scanned with the surface feature scanner while being rotated by the second electrode. After surface feature data of the workpiece have been collected, various process parameters can be adjusted to thereby achieve satisfactory surface treatment of the workpiece.

### BACKGROUND OF THE INVENTION

1. Technical Field

The present invention relates to electrochemical processing apparatuses and more particularly to a smart electrochemical processing apparatus capable of detecting surface features of workpieces automatically and configuring process parameters with program algorithm in real time.

2. Description of Related Art

In a nutshell, electrochemical processing entails applying a voltage such that redox reactions occur in an electrolyte between an anode and a cathode. This, coupled with different possible positions taken up by a workpiece, brings about different effects. For example, a workpiece positioned at the anode has its surface oxidized to form an oxidized film when connected to an electrical source. The oxidized film formed on the surface of the workpiece protects the workpiece from being oxidized further. By contrast, when connected to an electrical source, a workpiece positioned at the cathode draws metal ions in the electrolyte to the cathode to thereby electroplate the surface of the workpiece with the metal, and the anode dissolves to provide the electrolyte with more metal ions, thereby enhancing the electroplating of the workpiece.

However, conventional electrochemical processing apparatuses have drawbacks. They are bulky and thus take up much space. When operating, they cannot perform real-time adjustment of various workpieces in terms of process parameters, such as dynamic adjustment of current strength, time taken for performing electrochemical processing, the fine-tuning of replenishment of the electrolyte ingredient ratio, and temperature of the electrolyte. As a result, it is unlikely for the conventional electrochemical processing apparatuses to achieve satisfactory surface treatment of various workpieces.

### BRIEF SUMMARY OF THE INVENTION

It is an objective of the present invention to provide a smart electrochemical processing apparatus which has a low volume and thus takes up little space, scans surface features of workpieces automatically, and configures process parameters with program algorithm in real time, such that the workpieces undergo satisfactory surface treatment efficiently, thereby allowing the smart electrochemical processing apparatus to be especially applicable to the small-batch processing of diversified workpieces.

In order to achieve the above and other objectives, the present invention provides a smart electrochemical processing apparatus comprises a reaction container, an electrode unit and a surface feature scanner. The reaction container has an electrolytic tank. The electrode unit has a first electrode and a second electrode. The first electrode is fixedly positioned in the electrolytic tank of the reaction container. The second electrode is rotatably positioned in the electrolytic tank of the reaction container. The surface feature scanner is positioned at the reaction container. Hence, a workpiece positioned at the second electrode is put in the electrolytic tank and rotated by the second electrode such that the surface feature scanner automatically scans the workpiece for surface features. By the time the scan is done, surface feature data (such as dimensions, unit scan area, unit surface coarseness, surface material reflection spectrum composition, and surface reflection signal strength) of the workpiece has been collected to match spatial positions (such as the elevation position or rotation angle of the workpiece) corresponding to the data. Then, a control unit compiles the aforesaid data in an integrated manner and hands over the compiled data to a program for undergoing algorithmic computation to thereby determine the surface features data (such as total surface area, surface coarseness distribution, surface material distribution) of the workpiece. Eventually, the surface features data is transmitted to a control program for configuring the best process parameters (such as current strength, time taken for performing electrochemical processing, the fine-tuning of replenishment of the electrolyte ingredient ratio, and temperature of the electrolyte.) Upon completion of adjustment of various process parameters, the workpiece undergoes surface treatment through the redox reactions taking place in the electrolytic tank.

Preferably, related data collected by the surface feature scanner is transmitted by the control unit to a mobile device capable of computation such that a user can configure various process parameters and thus control the operation of the apparatus in its entirety with a mobile application installed on the mobile device. Furthermore, bidirectional data transmission takes place between the mobile application and a cloud device so as for the user to download and update the mobile application with the mobile device, search a process parameter database, handle process-related information, upload any situational parameter in real time, request online technical support, place orders for consumable materials and accessories, and upload all records of processing.

Preferably, the reaction container has therein an additive replenishment unit. The additive replenishment unit is positioned at the reaction container and has an additive replenishment cartridge and a pump connected to the additive replenishment cartridge. Hence, when the electrolytic tank is running out of electrolyte, it is feasible to turn on the pump to replenish the electrolytic tank by conveying an additive from the additive replenishment cartridge to the electrolytic tank.

The fine structures, features, assembly or use of the smart electrochemical processing apparatus provided by the present invention are described in detail later with reference to various embodiments of the present invention. However, persons skilled in the art understand that the detailed description and embodiments are illustrative of the present invention rather than restrictive of the claims of the present invention.

### BRIEF DESCRIPTION OF THE SEVERAL VIEWS OF THE DRAWINGS

FIG. 1 is a perspective view of a smart electrochemical processing apparatus of the present invention;

FIG. 2 is a cutaway view of the smart electrochemical processing apparatus of the present invention;

FIG. 3 is a partial cross-sectional view of a base of the smart electrochemical processing apparatus of the present invention;

FIG. 4 is a partial cross-sectional view of a top cover of the smart electrochemical processing apparatus of the present invention;

FIG. 5 is another perspective view of the smart electrochemical processing apparatus, showing a surface feature scanner scanning a workpiece according to the present invention; and

FIG. 6 is a schematic view of a mobile device and a cloud device which operate in conjunction with the smart electrochemical processing apparatus according to the present invention.

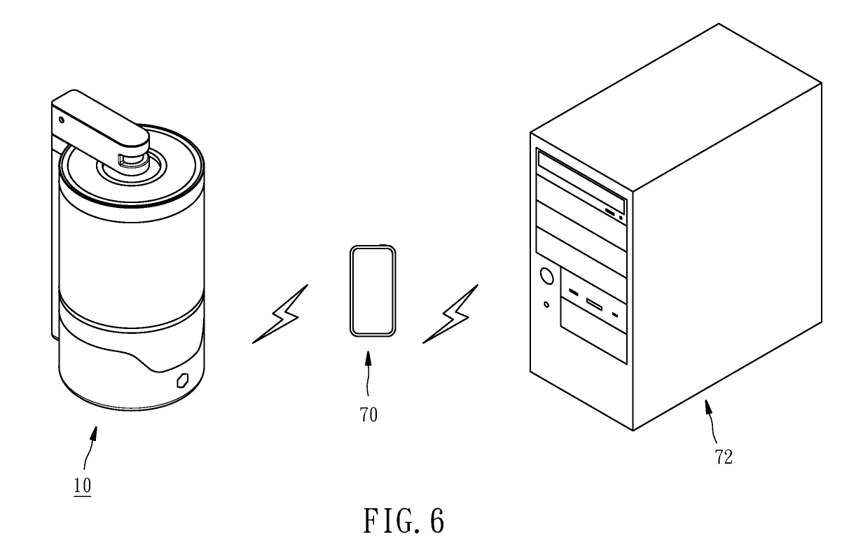

### DETAILED DESCRIPTION OF THE INVENTION

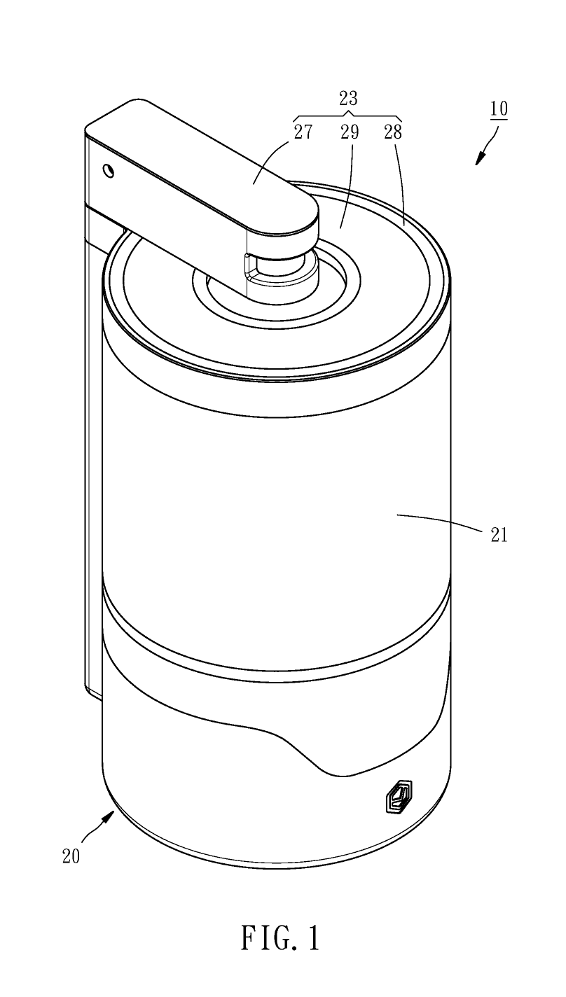

Referring to FIG. 1 through FIG. 4, a smart electrochemical processing apparatus 10 of the present invention comprises a reaction container 20, an electrode unit 40, a surface feature scanner 50 and a control unit 60.

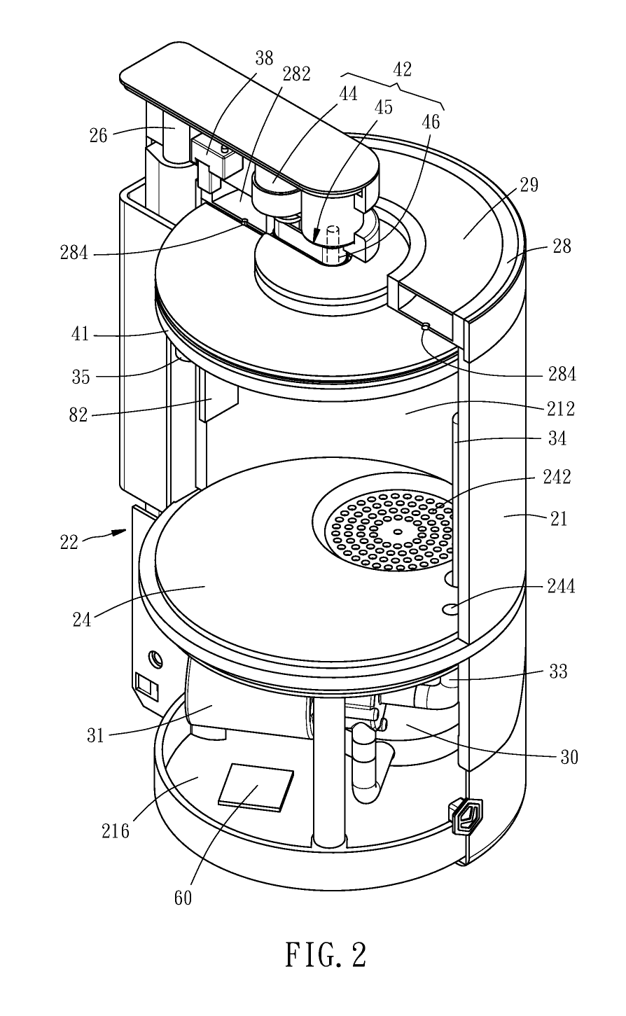

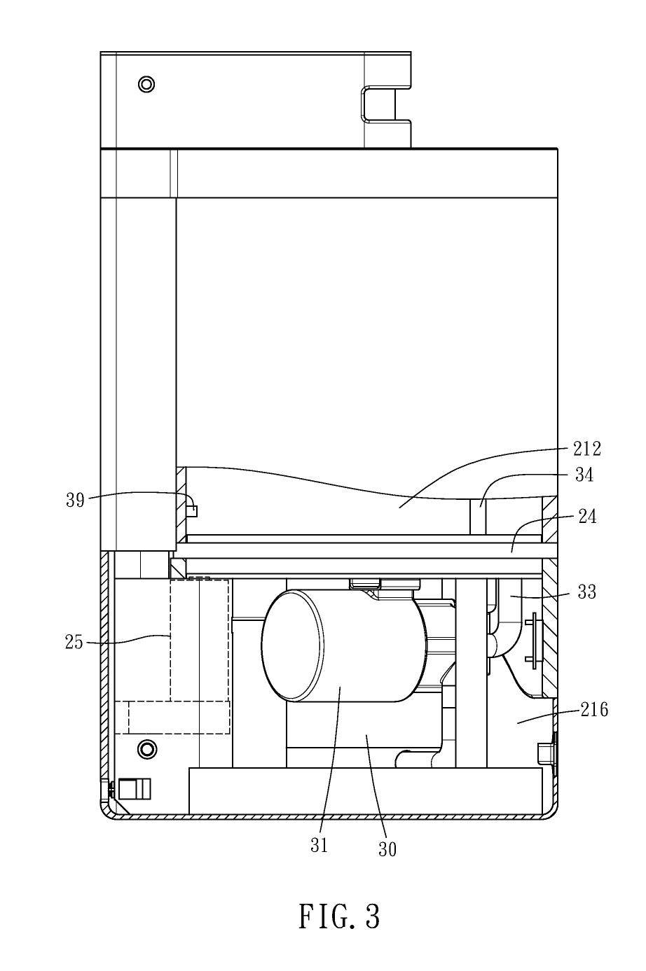

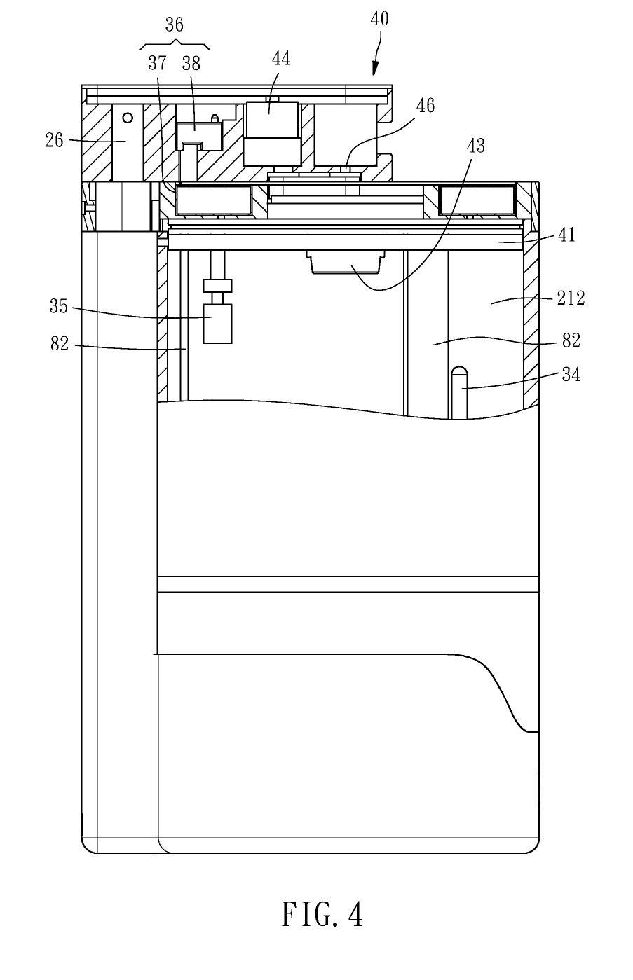

The reaction container 20 comprises a base 21, a linear driver 22 and a top cover 23. The base 21 has an electrolytic tank 212 and a tank opening 214 in communication with the electrolytic tank 212. The base 21 has a chamber 216 positioned below the electrolytic tank 212. The chamber 216 and the electrolytic tank 212 are separated by a baffle 24. The baffle 24 has an inlet 242 and an outlet 244. The inlet 242 and the outlet 244 are in communication with the electrolytic tank 212 and the chamber 216, respectively. Referring to FIG. 2 and FIG. 3, the linear driver 22 has a linear motor 25 and an elevation shaft 26. The linear motor 25 is positioned in the chamber 216 of the base 21. The elevation shaft 26 is positioned on the peripheral surface of the base 21 and connected to the linear motor 25; hence, the elevation shaft 26 is driven by the linear motor 25 to extend or retract. Referring to FIG. 2 and FIG. 4, the top cover 23 has an upper cover body 27 and a lower cover body 28. One end of the upper cover body 27 is connected to the elevation shaft 26 of the linear driver 22. The lower cover body 28 is positioned at the tank opening 214 of the base 21 and connected to the bottom surface of the upper cover body 27 such that the top cover 23 is driven by the elevation shaft 26 to cover or move away from the tank opening 214 of the base 21. The lower cover body 28 has a mounting space 282 and a plurality of through holes 284. Due to the through holes 284, the mounting space 282 of the lower cover body 28 is in communication with the electrolytic tank 212 of the base 21.

Referring to FIG. 2 and FIG. 3, the reaction container 20 further comprises a filter 30 and a circulation pump 31. The filter 30 is disposed in the chamber 216 of the base 21 and connected to the inlet 242 of the baffle 24. The circulation pump 31 is disposed in the chamber 216 of the base 21, connected to the filter 30, and connected to the outlet 244 of the baffle 24 through a drain pipe 33. Hence, the circulation pump 31 draws the electrolyte into the filter 30 for filtering out dust and impurities, and then the dust and impurities-free electrolyte is conveyed to the electrolytic tank 212 again, thereby purifying the electrolyte in circulation.

Referring to FIG. 2 and FIG. 4, the reaction container 20 has a heater 34, a liquid level sensor 35 and an additive replenishment unit 36. The heater 34 is fixed to the baffle 24 of the base 21 and disposed in the electrolytic tank 212 of the base 21 to keep the electrolyte at an appropriate operating temperature. The liquid level sensor 35 is disposed on the bottom surface of the lower cover body 28 of the top cover 23 and disposed in the electrolytic tank 212 of the base 21 to sense the electrolyte level. The additive replenishment unit 36 has an additive replenishment cartridge 37 and a pump 38. The additive replenishment cartridge 37 is removably disposed in the mounting space 282 of the lower cover body 28 and covered with a covering plate 29. The pump 38 is disposed in the upper cover body 27 and connected to the additive replenishment cartridge 37. Hence, if the electrolytic tank 212 is running out of electrolyte, an additive can be conveyed from the additive replenishment cartridge 37 to the electrolytic tank 212 via the through holes 284 and with the pump 38 and its pipeline. If the additive in the additive replenishment cartridge 37 is used up, it will be practicable to remove the covering plate 29, then take out the empty additive replenishment cartridge 37, and eventually mount a new additive replenishment cartridge 37 such that the replacement of consumed electrolyte can be carried out as needed.

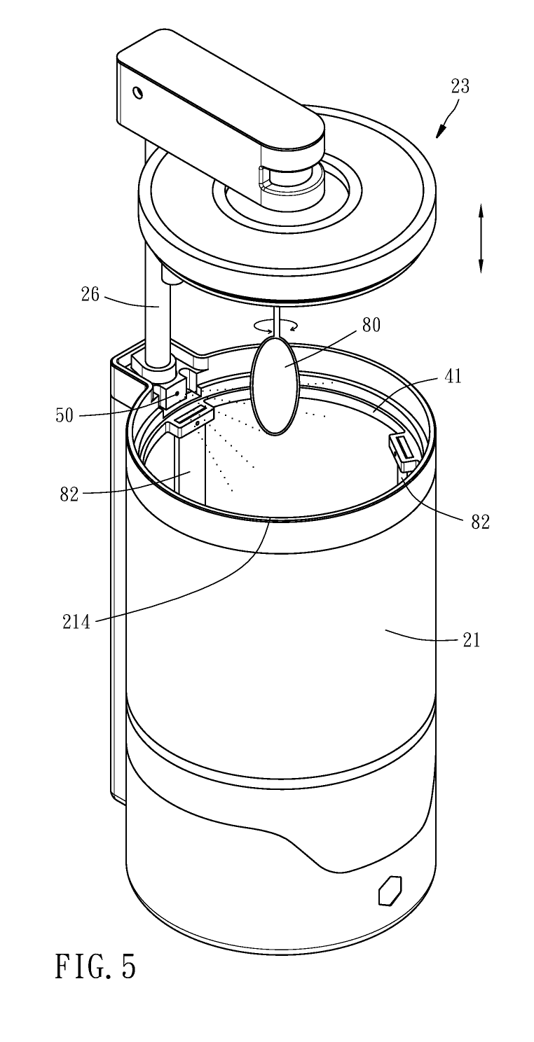

Referring to FIG. 4 and FIG. 5, the electrode unit 40 has a first electrode 41, a rotating driver 42 and a second electrode 43. In this embodiment, the first electrode 41 is the anode for mounting a metal electrode 82, and the second electrode 43 is the cathode for mount a workpiece 80 evenly. The rotating cathode 43 could irritate the electrolyte to facilitate the function of additives. Moreover, the rotating motion will generate a more homogenous electrical filed so as to improve the uniformity of deposition. The first electrode 41 is annular and disposed at the tank opening 214 of the base 21 of the reaction container 20. The rotating driver 42 is disposed in the upper cover body 27 of the top cover 23 of the reaction container 20 and has a rotating motor 44, a deceleration gear train 45 connected to the rotating motor 44, and a rotating shaft 46 connected to the deceleration gear train 45. The second electrode 43 is disposed on the bottom surface of the top cover 23 of the reaction container 20 and connected to the rotating shaft 46 of the rotating driver 42; hence, the second electrode 43 not only drives the workpiece 80 to elevate together with the top cover 23 but is also driven by the rotating driver 42 to thereby drive the workpiece 80 to rotate. This embodiment aims to electroplate the workpiece 80; to this end, the cathode is located at a mounting position (i.e., the second electrode 43) of the workpiece 80. To perform a process of anode oxidation on the workpiece 80, the anode is located at the mounting position (i.e., the second electrode 43) of the workpiece 80.

Referring to FIG. 5, the surface feature scanner 50 is disposed on the inner peripheral surface of the base 21 and located at the tank opening 214 of the base 21 to scan the workpiece 80 and thus collect surface features data (such as total surface area, surface coarseness distribution, and surface material distribution) of the workpiece 80.

Referring to FIG. 2, the control unit 60 is disposed in the chamber 216 of the base 21 of the reaction container 20 and electrically connected to the linear driver 22, the first electrode 41, the rotating driver 42, the pump 38, the circulation pump 31, the heater 34, the liquid level sensor 35 and the surface feature scanner 50 to thereby control and coordinate the operation of the aforesaid devices. The control unit 60 is connected to a mobile device 70 (such as a smartphone) wiredly or wirelessly; hence, a user is not only informed of the real-time status of the aforesaid devices through the mobile device 70 but is also able to control the aforesaid devices through the mobile device 70.

The fine structures of the smart electrochemical processing apparatus 10 of the present invention are described above. The process flow of the operation of the smart electrochemical processing apparatus 10 of the present invention is described below.

To operate the smart electrochemical processing apparatus 10 of the present invention, the user follows the steps outlined below: turn on the power; build the connection between the control unit 60 and the mobile device 70; and confirm the electrolyte level. If the electrolyte level is high from the beginning, it will be practicable for the user to restart the circulation pump 31 to thereby keep the electrolyte circulating. By contrast, if the electrolyte level is low from the beginning, it will be necessary for the user to start the pump 38 to thereby convey an additive from the additive replenishment cartridge 37 to the electrolytic tank 212. Afterward, the user turns off the pump 38 and then restarts the circulation pump 31 to thereby keep the electrolyte circulating, as soon as the liquid level sensor 35 senses that the electrolyte level has risen to an appropriate level.

With a temperature sensor 39, the user confirms the temperature of the electrolyte from the mobile device 70. If the temperature of the electrolyte is low, the user will turn on the heater 34 to heat up the electrolyte until the temperature of the electrolyte falls within an appropriate range of temperature and then begin the electrochemical process.

The user confirms whether the metal electrode 82 and the workpiece 80 are precisely mounted on the first and second electrodes 41, 43. Upon satisfactory confirmation that the metal electrode 82 and the workpiece 80 are precisely mounted, the user starts the linear driver 22, the rotating driver 42 and the surface feature scanner 50. The linear driver 22 drives the top cover 23 to descend together with the second electrode 43 and the workpiece 80. The rotating driver 42 drives the second electrode 43 to rotate together with the workpiece 80. The surface feature scanner 50 begins scanning the workpiece 80 to collect surface features data of the workpiece 80 and send the surface features data to the control unit 60; meanwhile, the control unit 60 records the elevation position of the linear driver 22 and the rotation position of the rotating driver 42.

In this embodiment, the surface feature scanner 50 works by protecting a laser dot onto the workpiece 80, using a light sensing module to perceive the time spent on receiving a reflected light beam so as to calculate the distance between the surface feature scanner 50 and the workpiece 80, and eventually calculating the surface area of the workpiece 80 with reference to the descent of the top cover 23 and the rotation of the second electrode 43. Specifically speaking, after the workpiece 80 has been mounted on the second electrode 43, the linear driver 22 drives the top cover 23 to descend for a specific distance and then come to a halt. Then, the laser dot emitted from the surface feature scanner 50 scans the workpiece 80 transversely to measure the distance between a semi-outline of the workpiece 80 and the surface feature scanner 50 at a first height. Afterward, when driven by the rotating driver 42, the second electrode 43 drives the workpiece 80 to rotate by 180 degrees such that the surface feature scanner 50 keeps scanning the other semi-outline of the workpiece 80. When a round of scan is done, the top cover 23 is driven by the linear driver 22 to descend for the same distance. Then, the surface feature scanner 50 keeps scanning the two semi-outlines of the workpiece 80 at a second height. The aforesaid process flow repeats until the two semi-outlines of the workpiece 80 at different heights are thoroughly scanned. Upon completion of the scan, related data collected by the surface feature scanner 50 is sent by the control unit 60 to the mobile device 70 for calculating the surface area of the workpiece 80. After the surface area of the workpiece 80 has been calculated, the mobile device 70 configures various process parameters, such as the rotation speed of the rotating driver 42, current density, and current duration. After the aforesaid process parameters have been configured, the workpiece 80 undergoes surface treatment through the redox reactions taking place between the first and second electrodes 41, 43 in the electrolytic tank 212.

To speed up the aforesaid measurement process of the workpiece 80, it is feasible to replace the aforesaid dot scan with a surface scan, that is, performing a two-dimensional scan on the surface of the workpiece 80 by light wave or sound wave reflection, so as to measure the distance between each scan point of the workpiece 80 and an emission source and then calculate the surface area of the workpiece 80 according to the distance and geometrical relationship. The aforesaid measurement process can be carried out block by block, if the range of the operating distance of the emission source is not wide enough. It is also practicable to reconstruct the surface profile and calculate the surface area by image analysis; for example, the distance between a camera lens and image pixels of the workpiece 80 is calculated by the principle about how two images are captured with a device in a way similar to how the two eyes of a human being work, so as to infer the surface area of the workpiece 80.

When the above processing process is done, a point to note is that if the user fails to remove the workpiece 80 from the electrolyte instantly, an applied current can be supplied to the second electrode 43 such that the cathode is formed at the position of the workpiece 80 so as to prevent corrosion. Referring to FIG. 7, with a mobile application (APP) installed on the mobile device 70, the user uploads data about the whole processing process to a cloud device 72 for storage so that the stored data can serve as reference for use in the next operation session. In case a trouble happens to the operation process, the user can upload the trouble-related data to the cloud device 72 by the APP, thereby allowing an engineer to assist the user in trouble-shooting. The control unit 60 is connected directly to the cloud device 72 by the Internet and thus capable of uploading operation-related data and related data in real time; hence, the user performs remote surveillance and control over the smart electrochemical processing apparatus 10 with the APP of the mobile device 70.

Although the present invention is illustrated with the aforesaid embodiments, the configured position of the surface feature scanner 50 is not restricted to the tank opening 214 of the electrolytic tank 212; instead, the surface feature scanner 50 can also be disposed inside the electrolytic tank 212, provided that the scan is not compromised. Furthermore, the workpiece 80 and the second electrode 43 are not necessarily disposed at the top cover 23; instead, the workpiece 80 and the second electrode 43 can be disposed anywhere, provided that a mechanism enables the workpiece 80 and the second electrode 43 to rotate or move. It is feasible for the liquid level sensor 35 to be disposed outside the electrolytic tank 212 in accordance with its sensing mode to thereby keep the electrolyte within a range of electrolyte level. It is also feasible for the liquid level sensor 35 to be disposed outside the additive replenishment cartridge 37, such that the APP reminds the user to replace the consumed additive when the additive is running out.

In conclusion, a smart electrochemical processing apparatus 10 of the present invention has a smaller volume and thus takes less space than its conventional counterparts. When in use, the smart electrochemical processing apparatus 10 of the present invention adjusts various parameters in real time according to surface features of a workpiece. Hence, the smart electrochemical processing apparatus 10 of the present invention is suitable for processing a small amount of diverse workpieces, such that the workpieces undergo optimal surface treatment efficiently, thereby achieving the objectives of the present invention. The smart electrochemical processing apparatus 10 of the present invention operates in conjunction with a mobile device 70 and an APP for the sake of remote control, such that it is not only operated and managed by non-professional users easily, but it also incurs less equipment cost.

What is claimed is:

1. A smart electrochemical processing apparatus, comprising:
a reaction container having an electrolytic tank;
an electrode unit having a first fixed electrode positioned in the electrolytic tank of the reaction container, and a second rotatable electrode positioned in the electrolytic tank of the reaction container; and
a surface feature scanner positioned at the reaction container and configured to automatically scan an intended element positioned at the second electrode and collect surface features data of the intended element.

2. The smart electrochemical processing apparatus of claim 1, wherein the reaction container further comprises a linear driver positioned on a peripheral surface of the reaction container, and a disconnectable top cover positioned at a tank opening of the electrolytic tank and connected to the linear driver.

3. The smart electrochemical processing apparatus of claim 2, wherein the electrode unit has a rotating driver positioned at the top cover and connected to the second electrode.

4. The smart electrochemical processing apparatus of claim 3, further comprising a control unit electrically connected to the linear driver, the rotating driver and the surface feature scanner.

5. The smart electrochemical processing apparatus of claim 4, wherein the control unit is connected to a mobile device wiredly or wirelessly.

6. The smart electrochemical processing apparatus of claim 5, wherein the mobile device performs bidirectional data transmission by a mobile application and a cloud device.

7. The smart electrochemical processing apparatus of claim 1, wherein the reaction container further comprises a filter positioned in close proximity to the electrolytic tank and a circulation pump connected to the filter.

8. The smart electrochemical processing apparatus of claim 1, wherein the reaction container further comprises a heater positioned in the electrolytic tank and a temperature sensor positioned in the electrolytic tank.

9. The smart electrochemical processing apparatus of claim 1, wherein the reaction container further comprises a liquid level sensor positioned in the electrolytic tank.

10. The smart electrochemical processing apparatus of claim 1, further comprising an additive replenishment unit positioned at the reaction container, and having an additive replenishment cartridge and a pump connected to the additive replenishment cartridge and configured to transfer an additive from the additive replenishment cartridge to the electrolytic tank.
